(19) United States
(12) Patent Application Publication
(10) Pub. No.: US 2007/0023973 A1
(43) Pub. Date: Feb. 1, 2007

(54) Process for extruding solid state polymer using ultrasound and device therefor

(76) Inventors: Yousoo Han, Daejeon (KR); Seongchan Park, Cheongju-si (KR); Dongjin Kim, Cheongiu-si (KR); Sangho Han, Cheongiu-si (KR); Jungil Son, Gunpo-si (KR); Yunhwan Hwang, Seoul (KR)

Correspondence Address: CANTOR COLBURN, LLP, 55 GRIFFIN ROAD SOUTH, BLOOMFIELD, CT, 06002, US

(21) Appl. No.: 11/471,828

(22) Filed: Jun. 21, 2006

(30) Foreign Application Priority Data
Jul. 29, 2005 (KR) 10-2005-0069346

(51) Int. Cl. B29C 47/00

(52) U.S. Cl. 264/444; 425/174.2; 425/376.1

(57) ABSTRACT

Disclosed herein is a solid-state extrusion-orientation process. The process produces a polymer-oriented profile by compressing a billet through an extrusion die, in which the billet comprises crystalline or semi-crystalline polymers or a composite containing the polymers and an organic or inorganic filler. The process comprises the steps of preheating a pressure chamber to a temperature of a polymer's melting point or less, applying ultrasound to the extrusion die positioned next to the pressure chamber and having a smaller cross-sectional area that the pressure chamber, and extruding the billet through the pressure chamber and the extrusion die to produce the polymer-oriented profile. This process eliminates the step of heating the extrusion die, thereby ensuring convenient and rapid operation while providing a polymer profile having a smooth surface without any defects.

### FIELD OF THE INVENTION

The present invention relates to a solid-state extrusion-orientation process using ultrasound, and an apparatus therefor. More particularly, the present invention relates to a solid-state extrusion-orientation process, in which ultrasound is applied to an extrusion die instead of heating the extrusion die as in a conventional process when molding a preformed solid-state polymer billet, and allows the solid-state extrusion to be performed rapidly without controlling the temperature of the extrusion die, which has been performed for lubrication of an interface between the polymer billet and the extrusion die in the conventional process, in order to ensure convenient and rapid operation while enhancing surface properties, and an apparatus therefor.

### BACKGROUND OF THE INVENTION

Among polymers having a chain of carbon-carbon bonds as a basic backbone structure, some polymers are transformed to form crystals while being cooled and solidified upon molding of the polymers such as an extrusion process. However, these crystals have no orientation, and are randomly oriented, thereby causing deterioration in mechanical properties.

If the chains constituting these crystals are orientated in a predetermined direction, the mechanical strength and properties are remarkably improved, whereas the specific gravity is significantly reduced due to a distance between the oriented polymeric chains. In addition, when using a polymeric composite, it is possible to produce a material having desired properties depending on components of fillers. For example, when the filler is artificial woods formed of a composite containing crystalline polymers and tree powders or tree-fibers, it is possible to achieve an appearance and structure very similar to those of a natural tree according to orientation thereof. Thus, various orientation processes and techniques providing such characteristics have been developed.

In one of representative processes, after a solid-state preform of a polymer is heated at temperatures below its melting point for a predetermined period of time, the polymer is oriented through application of force thereto in a predetermined direction. However, such a process has problems in that products thereof have defects in shape and surface quality as well as irregular orientation.

As one of the processes suggested to address the problems, there is a solid-state extrusion-orientation process which orients polymers using a heated die (see U.S. Pat. No. 5,204,045). According to this process, a polymeric preform is heated to temperatures below its melting point, and forced to flow through the die having a narrow inner diameter in order to orient the polymer. Specifically, since an inner cross-sectional area of the die is gradually decreased at a constant ratio, chains of the polymer are oriented in a direction of pressure while the preform passes through the die. Here, since there arises severe friction between the preform and the dies having the narrow inner diameter when the preform passes through the die, the die is heated to make lubrication operation therebetween.

In this process, since the preform is forced to pass through the die having the narrow inner diameter, it is possible to form a final polymer-oriented product, which has smaller surface defects than that of a product produced by other conventional processes. However, this process has a problem in that it is necessary to constantly heat the die in order to maintain the metallic die at a predetermined temperature, and that the friction is still severely generated when the preform passes through the die.

### SUMMARY OF THE INVENTION

It is an object of the present invention to solve the problems of the conventional process, and other technical problems which have been required to be solved in the art.

With a result of extensive investigations and experiments, the inventors of the present invention have found that, when vibrating the dies through application of a predetermined ultrasound pulse to a die, instead of heating the die, such that a preform of a polymer heated in a pressure chamber comes into contact with the die shaken by the ultrasound, lubrication effect was maximized on a frictional surface between the die and the heated preform, and the final polymer orientation profile became excellent in terms of surface molding properties. With this result, the inventors of the present invention completed the present invention.

In accordance with one aspect of the present invention, the above and other objects can be accomplished by the provision of a solid-state extrusion-orientation process of producing a polymer-oriented profile by compressing a polymer billet through an extrusion die, the polymer billet being one of a billet comprising crystalline or semi-crystalline polymers and a billet of a composite containing the polymers and an organic or inorganic filler, the process comprising the steps of: preheating a pressure chamber to a temperature of a polymer's melting point or less; applying ultrasound to the extrusion die positioned successive to the pressure chamber and having a smaller cross-sectional area than the pressure chamber; and extruding the polymer billet through the pressure chamber and the extrusion die to produce the polymer-oriented profile.

Unlike the conventional process in which the extrusion die is heated, the solid-state extrusion-orientation process of the present invention performs the extrusion while applying the ultrasound to the extrusion die. As a result, the overall costs for the process lower due to reduction of time and energy for temperature control, and the processing speed thereof increases in comparison to the conventional process due to enhanced lubrication effect, which is caused by ultrasonic energy and allows the polymer billet to easily pass through the extrusion die. In addition, the solid-state extrusion-orientation process effectively prevents the surface defects which can be generated by the conventional process, thereby providing a smooth and strong polymer-oriented profile.

The polymer is not limited to a specific kind so long as it has such a fluidity to permit the extrusion when being heated and has crystalline or semi-crystalline structures when existing in a shape of a preform (billet). Preferably, the polymer may be a thermoplastic polymer having a linear chain of molecules. Preferred examples of the thermoplastic polymer include polyethylene, polypropylene, polyethylene terephthalate, and the like.

According to the present invention, the solid-state extrusion is performed for the composite billet containing the polymers and the organic or inorganic filler as well as the billet of the polymer, as described above. Herein, for convenience of description, both the billet of the polymer and the composite billet containing the polymers and the fillers are commonly referred to as a “polymer billet.”

The filler is an organic or inorganic material, and is not limited to a specific kind. Preferably, the filler may be tree powders, tree fibers, alumina, silica, talc, and the like.

The pressure chamber serves to supply driving force for heating the polymer billet to the polymer's melting point or less so as to permit the extrusion of the polymer billet, and for extruding the polymer billet.

The extrusion die has a smaller area than the pressure chamber so as to permit the solid-state extrusion, so that the extrusion is performed in such a way that the polymer billet is forcibly pushed into the die after being heated and compressed by the pressure chamber. Accordingly, during the extrusion, the crystals of the polymer billet are subjected to a large pressure, and oriented in a progressing direction. The extrusion die preferably has a tapered structure (inclined surface) such that it has an area gradually reduced in an extrusion direction in order to minimize friction between the polymer billet and the extrusion die having a small area when the polymer billet enters the extrusion die.

However, since the interface between the polymer billet and the inner surface of the extrusion die is subjected to large friction in spite of the tapered structure, it is necessary for the conventional process to heat the extrusion die to a temperature higher than that of the pressure chamber, that is, to the range of 0.9˜1.2 times temperature of the polymer's melting point. Accordingly, in the conventional process, although the pressure chamber and the extrusion die are separately heated to have different temperatures, there is a limit in separate control of them to have the different temperatures due to the structure wherein the extrusion die is positioned successive to the pressure chamber. For example, when the extrusion die is set to have a temperature higher than the melting point of the polymer, thermal conduction occurs from the extrusion die to the pressure die, and increases the temperature of the pressure die to such a degree that the pressure die has a temperature near to or the same as that of the extrusion chamber so that the polymer billet is excessively melted at the surface thereof during the extrusion, and fails to have ideal solid-state orientation.

On the contrary, in the present invention, ideal solid-sate extrusion-orientation can be achieved since the ultrasound is applied to the extrusion die instead of heating the extrusion die. As a result, the present invention enables the temperatures of the pressure chamber and the extrusion die to be easily controlled while preventing the extrusion die from being heated above the melting point of the polymer. In some case, the extrusion die may be heated to have approximately the same temperature as that of the pressure chamber. Even in this case, there is a merit in that the temperature control can be easily performed due to continuous arrangement of the pressure chamber and the extrusion chamber, unlike the conventional technique.

The characteristics of the present invention will be described in detail hereinafter.

According to the present invention, the ultrasound is applied to the extrusion die so as to lower the friction at the interface between the inner surface of the extrusion die and the polymer billet, thereby inducing lubrication therebetween. When the polymer billet is brought into contact with the extrusion die under ultrasonic shaking after being heated to the polymer's melting point or less for a predetermined period of time within the pressure chamber, instant lubrication effect is realized at a frictional surface between the extrusion die and the polymer billet. As a result, the polymer billet can easily pass through the extrusion die which has the inner diameter reduced at a constant ratio, so that a final product has an excellent surface in comparison to the conventional solid-state extrusion-orientation process adopting the extrusion die heating manner.

The ultrasound applied to the extrusion die has a frequency of a few˜several dozens of kHz according to properties of a polymer to be extracted, that is, a frequency of 1˜100 kHz. An orientation degree of the polymer can be obtained using a difference between tensile strengths of the polymer before and after the orientation. When comparing change in tensile strength of extrusion-oriented profiles obtained by the process of the present invention with that of the conventional process, it can be appreciated that the orientation degree obtained by the process of the present invention is greater than or equal to the orientation degree obtained by the conventional process.

In accordance with another aspect of the present invention, there is provided a pressure-tensioning orientation apparatus, which can effectively perform the method of the present invention.

The pressure-tensioning orientation apparatus according to the present invention comprises: a pressure chamber adapted to permit temperature elevation and to supply pushing force to a polymer billet towards an extrusion die; the extrusion die positioned successive to the pressure chamber and having a smaller cross-sectional area than that of the pressure chamber; and an ultrasound application unit to apply ultrasound to the extrusion die.

The cross-sectional area of the extrusion die can be determined according to various factors including kinds of polymer, molecular weights of polymers, and the like. Preferably, the extrusion die has about 0.3˜0.5 times cross-sectional area of a polymer billet which will be provided as a preform. It can also be expressed with a draw ratio, which can be provided as a square value of a cross-sectional area of the polymer billet/a cross-sectional area of a final orientation profile (an area of die outlet). Preferably, the extrusion die is constructed to have a draw ratio of 4 to 10.

The ultrasound application unit may be mounted at any place inside or outside of the extrusion die so long as the object of the present invention can be achieved through application of the ultrasound having a predetermined pulse to the extrusion die.

The ultrasound application unit preferably comprises a controller which can control frequency and amplitude of the ultrasound.

As apparent from the above description, the solid-state extrusion-orientation process of the present invention applies ultrasound to an extrusion die, and eliminates the step of heating the extrusion die, ensuring convenient and rapid operation while providing a polymer profile having a smooth surface without any defects. Accordingly, the present invention can be widely and effectively applied to manufacturing of crystalline or semi-crystalline polymer products.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view illustrating a pressure chamber, an extrusion die, and an ultrasound application unit in accordance with one embodiment of the present invention; and

FIG. 2 is a schematic diagram illustrating one exemplary construction of a pressure-tensioning orientation apparatus to which the components shown in FIG. 1 are applied.

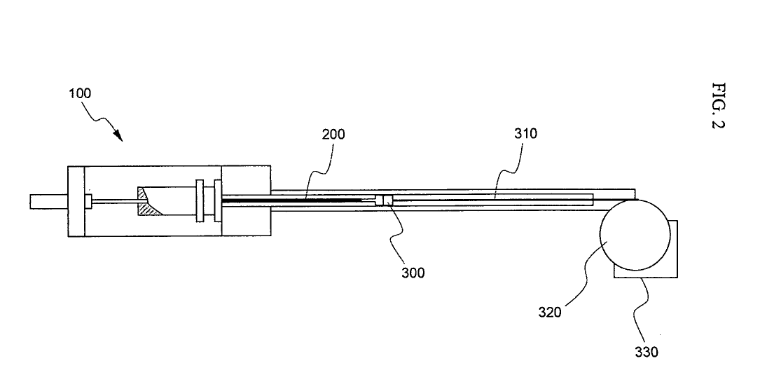

### DETAILED DESCRIPTION OF PREFERRED EMBODIMENTS

Preferred embodiments of the present invention will be described hereinafter.

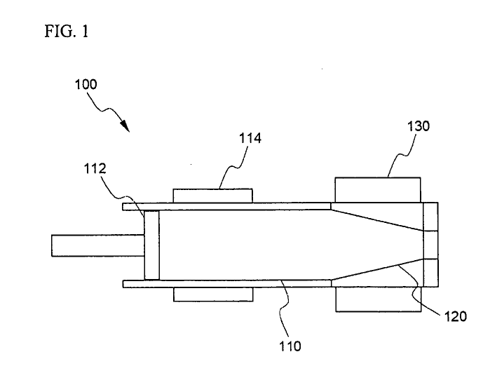

FIG. 1 shows a solid-state orientation extrusion apparatus in accordance with one embodiment of the present invention.

Referring to FIG. 1, a pressure-tensioning orientation apparatus 100 according to the present invention comprises: a pressure chamber 110, an extrusion die 120, and an ultrasound application unit 130. The pressure chamber 110 is provided at one side thereof with a movable ram 112 serving to push a polymer billet (not shown) towards the extrusion die 120, and at an outside thereof with a heating unit 114.

The ram 112 serves to force the polymer billet to pass through the extrusion die 110 by applying a predetermined pressure to the polymer billet. The heating unit 114 heats the pressure chamber 110 to a temperature of a polymer's melting point or less. The heating unit 114 may be installed within the pressure chamber 110. Preferably, the temperature of the pressure chamber 110 is controlled so as to be in the range of about 0.6˜0.9 times temperature of the polymer's melting point.

The extrusion die 120 is positioned successive to the pressure chamber 110, and has an inner configuration which is inclined at a predetermined angle such that an inner diameter of the extrusion die is gradually narrowed towards an end thereof.

The inner angle of the extrusion die 120 is preferably set to 10˜40 degrees. The extrusion die 120 has a length depending on a draw ratio. An extrusion speed is suitably controlled according to a cross-sectional area of the polymer billet, and is preferably 0.1˜2 m/min.

Although the ultrasound application unit 130 is shown as being installed at an outside of the extrusion die 120 in the drawing, it can be installed within the extrusion die 120.

After being extruded from the extrusion die shown in FIG. 1, a polymer profile 200 is sequentially brought into contact with a cable 300, a spool 310 and a gripper connected with a motor 320, and then discharged to the outside.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A solid-state extrusion-orientation process of producing a polymer-oriented profile by compressing a polymer billet through an extrusion die, the polymer billet being one of a billet comprising a crystalline or semi-crystalline polymer and a billet comprising a composite containing the polymer and an organic or inorganic filler, the process comprising the steps of:
preheating a pressure chamber to a temperature of a polymer's melting point or less;
applying ultrasound to the extrusion die positioned successive to the pressure chamber and having a smaller cross-sectional area than the pressure chamber; and
extruding the polymer billet through the pressure chamber and the extrusion die to produce the polymer-oriented profile.

2. The process as set forth in claim 1, wherein the polymer is a thermoplastic polymer having a linear chain of molecules, and the filler is one of tree powders, tree fibers, alumina, silica and talc.

3. The process as set forth in claim 1, wherein the pressure chamber heats the polymer billet in the range of 0.6˜0.9 times temperature of the polymer's melting point.

4. The process as set forth in claim 1, wherein the extrusion die has a tapered structure (inclined surface) such that it has a cross-sectional area gradually reduced in an extrusion direction to minimize friction between the polymer billet and the extrusion die having a small inner diameter when the polymer billet enters the extrusion die.

5. The process as set forth in claim 1, wherein the extrusion die has about 0.3˜0.5 times cross-sectional area of the polymer billet.

6. The process as set forth in claim 1, wherein the ultrasound is applied to the extrusion die at a frequency of 1˜100 kHz.

7. A pressure-tensioning orientation apparatus to perform a process according to claim 1, comprising:
a pressure chamber adapted to permit temperature elevation and to supply pushing force to a polymer billet towards an extrusion die;
the extrusion die positioned successive to the pressure chamber and having a smaller cross-sectional area than that of the pressure chamber; and
an ultrasound application unit to apply ultrasound to the extrusion die.

8. The apparatus as set forth in claim 7, wherein the extrusion die has a draw ratio of 4˜10.

9. The apparatus as set forth in claim 7, wherein the ultrasound application unit is installed inside or outside of the extrusion die.

10. The apparatus as set forth in claim 7, wherein the ultrasound application unit comprises a controller capable of controlling frequency and amplitude of the ultrasound.
